(19) United States
(12) Patent Application Publication
(10) Pub. No.: US 2015/0324074 A1
(43) Pub. Date: Nov. 12, 2015

(54) Digital Book Graphical Navigator

(71) Applicant: Alan P. Van Winkle, Bainbridge Island, WA (US)

(72) Inventor: Alan P. Van Winkle, Bainbridge Island, WA (US)

(73) Assignee: VAN WINKLE STUDIO LLC, Poulsbo, WA (US)

(21) Appl. No.: 14/271,702

(22) Filed: May 7, 2014

(51) Int. Cl. G06F 3/0483; G06F 3/0486; G06F 3/0488; G06F 3/0482; G06F 3/0484

(52) U.S. Cl. CPC G06F 3/0483; G06F 3/0482; G06F 3/04847; G06F 3/04842; G06F 3/04883; G06F 3/0486

(57) ABSTRACT

This touch-screen computer graphical user interface navigation mechanism consists of a horizontally oriented list of miniature images representing pages in a digital book. From any page, the user can quickly navigate to any other page in the book by performing a two-finger tap, swiping the list left or right, and selecting an image to go to that page. When the book contains chapters, a secondary list is used to navigate through the book chapters. The miniature images in the lists are displayed in the same order as the pages and chapters in the book, from beginning to end. The user swipes left or right, swiftly or slowly, forward or backward, to the desired page. The user selects the miniature image to navigate to the page. With the two-finger tap and these sliding lists, the user can quickly and easily navigate through the chapters and pages of a digital book.

### CROSS-REFERENCES RELATED TO THE APPLICATION

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not Applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

This invention is generally related to computer software and user interaction with the computer. More specifically, it is related to the user interaction with the tablet (touch-screen) computer and the user interaction with digital (electronic) books. As the user (reader) views and reads a digital book, he must perform the act of turning the page, just as with a traditional paper book. The user may also want to go to a specific page in the book. The act of turning pages in a digital book or selecting a specific page to view is also known as navigating or navigation through the digital book. This invention is a new navigational graphical user interface (GUI) and navigational method for digital books.

Existing user interfaces for interacting with a digital book come in various forms depending on the computer device such as the personal computer, tablet computer, or smart phone. Conventional digital book user interfaces include features like a single-finger swipe on the tablet computer screen to turn the page, entering a page number on the screen (using the keyboard) to skip directly to a specific page in the digital book, or selecting a line item in a text-oriented table of contents to navigate to a specific page in the book. These conventional methods for navigating through a digital book often mimic the familiar experience of reading a paper book.

This invention provides a new user navigation experience in a digital book, taking full advantage of the touchable user interaction of the tablet computer such as tapping and swiping, the graphical display, and the graphical content and representations of the digital book.

### BRIEF SUMMARY OF THE INVENTION

This invention, called the Digital Book Graphical Navigator, is a new user interface for the tablet computer digital book and allows the user (reader) to navigate through a digital book. It consists of the display and use of a new graphical user interface (GUI). It is comprised of two parts—the Digital Book Graphical Navigator Page Slider and the Digital Book Graphical Navigator Chapter Slider. It displays the digital book table of contents in graphical form, allows the user to rapidly view the graphical table of contents from any page in the book, and allows the user to rapidly navigate to any page in the book from any page.

This new graphical navigation is used with, but not limited to, illustrated electronic books. The Digital Book Graphical Navigator takes advantage of the tablet computer graphical display and user actions such as tapping and swiping on the tablet computer screen. This new GUI takes the user experience beyond mimicking the reading of a paper book on an electronic device and into the experience of reading and navigating through a digital book on a digital device.

This new navigation with the Digital Book Graphical Navigator is based on a graphical sliding mechanism called the Digital Book Graphical Navigator Page Slider. The Digital Book Graphical Navigator Page Slider consists of a horizontally oriented list of thumbnail (miniature) images of the pages in the electronic book. Each thumbnail image represents a page in the electronic book.

The user displays the Digital Book Graphical Navigator by performing a two-finger tap (two fingers tapped simultaneously) on the tablet computer screen. In a simple illustrated book, the Digital Book Graphical Navigator Page Slider is displayed on a small portion at the bottom of the tablet computer screen, overlaying that portion of the content of the page, but does not otherwise interfere with the features and functions of the rest of the visible page in the book. The user performs a swiping action on the Digital Book Graphical Navigator Page Slider from left to right to view the miniature content of several pages of the book on one screen. The thumbnail images in the Digital Book Graphical Navigator Page Slider are displayed in the same order as the pages in the book, from beginning to end.

The user can clearly see the image of each page in its miniature form in the Digital Book Graphical Navigator Page Slider. The user swipes from left to right on the graphical navigation either swiftly or slowly. A swift swipe moves the thumbnail images forward or backward rapidly until the end of the list of pages is reached. A slow, steady swipe slides the Digital Book Graphical Navigator Page Slider with a clear view of thumbnail images for review by the user. A single tap on an arrow at each end of the Digital Book Graphical Navigator Page Slider advances the thumbnail images. Once the user finds a desired page, he performs a single-finger tap on the Digital Book Graphical Navigator Page Slider thumbnail image corresponding to the desired page. The selected page is displayed on the main screen of the tablet computer, ready to read. The Digital Book Graphical Navigator fades from view after a period of time or the user can perform a single-finger tap on the screen away from the Digital Book Graphical Navigator to hide it.

The Digital Book Graphical Navigator can also be used with digital books containing chapters. The pages are displayed in the Digital Book Graphical Navigator Page Slider as thumbnail images as previously described, and in addition, another smaller horizontally oriented list is displayed above the Digital Book Graphical Navigator Page Slider, and it contains thumbnail images each representing a chapter in the book. This smaller horizontally oriented list is called the Digital Book Graphical Navigator Chapter Slider, and it contains thumbnail images that represent the chapters in the digital book. The user scrolls through the Digital Book Graphical Navigator Chapter Slider and taps the desired chapter to display the pages for that chapter in the Digital Book Graphical Navigator Page Slider. The user then can select a desired page by tapping the Digital Book Graphical Navigator Page Slider to navigate to the page.

### BRIEF DESCRIPTION OF THE DRAWINGS

Refer to the drawings submitted with this specification for figure and drawing references. The content of the example digital book pages in these drawings is for example only and for the purpose of clearly explaining the invention.

FIG. 1 illustrates a typical page in an illustrated digital book on a tablet computer.

FIG. 2 illustrates a typical navigation paradigm of a digital book on a tablet computer. This is the old, traditional turning of a page in the digital book.

FIG. 3 is a simple illustration of the next page in a digital book, after turning the page with a finger swipe in FIG. 2.

FIG. 4 illustrates the method and use of this invention. It illustrates the action of the user (reader) to be performed to display the invention, the Digital Book Graphical Navigator.

FIG. 5 illustrates the method and use of this invention and shows the Digital Book Graphical Navigator Page Slider displayed on the tablet computer after the user performs a two-finger tap depicted in FIG. 4.

FIG. 6 illustrates the user action performed to select a desired item in the Digital Book Graphical Navigator Page Slider to navigate to that page in the digital book.

FIG. 7 illustrates the method of this invention to navigate to and display a selected page in the digital book after the user has performed a selection action in the Digital Book Graphical Navigator Page Slider as depicted in FIG. 6. It depicts the selected page and the state of the Digital Book Graphical Navigator Page Slider.

FIG. 8-9 illustrate the method and use of the Digital Book Graphical Navigator Page Slider to rapidly view all of the thumbnail (miniature) images displayed in the Digital Book Graphical Navigator Page Slider. FIG. 8 depicts the right-to-left user swipe action to advance the Digital Book Graphical Navigator Page Slider images forward. FIG. 9 depicts the left-to-right user swipe action to display previous images in the Digital Book Graphical Navigator Page Slider.

FIG. 10-12 illustrate the method and use of this invention to move the Digital Book Graphical Navigator from the bottom of the tablet computer screen to the top.

FIG. 13 illustrates the method and use of the Digital Book Graphical Navigator to dismiss the Digital Book Graphical Navigator with a single-finger tap to display the full digital book page.

FIG. 14 illustrates the view that is the result of removing the Digital Book Graphical Navigator from view as described in FIG. 14.

FIG. 15 illustrates how to view the Digital Book Graphical Navigator when in use with a book containing multiple chapters. The two-finger tap action is used to display the Digital Book Graphical Navigator which includes the Digital Book Graphical Navigator Page Slider and the Digital Book Graphical Navigator Chapter Slider.

FIG. 16 illustrates the view of the Digital Book Graphical Navigator Chapter Slider and Page Slider when used with a book containing multiple chapters.

FIG. 17 illustrates the user action of scrolling through the Digital Book Graphical Navigator Chapter Slider when used with a book containing chapters, scrolling the chapters forward in the digital book.

FIG. 18 illustrates the user action of scrolling through the Digital Book Graphical Navigator Chapter Slider when used with a book containing chapters, scrolling the chapters backward in the digital book.

FIG. 19 illustrates the use of the Digital Book Graphical Navigator Chapter Slider and the user action of selecting a chapter in a digital book containing chapters.

FIG. 20 illustrates the use of the Digital Book Graphical Navigator Chapter Slider when in use with a chapter book after the action of selecting a chapter and selecting a page to navigate to a specific page.

FIG. 21 illustrates the method and use of the Digital Book Graphical Navigator to dismiss the Digital Book Graphical Navigator when in use with a chapter book.

### DETAILED DESCRIPTION OF THE INVENTION

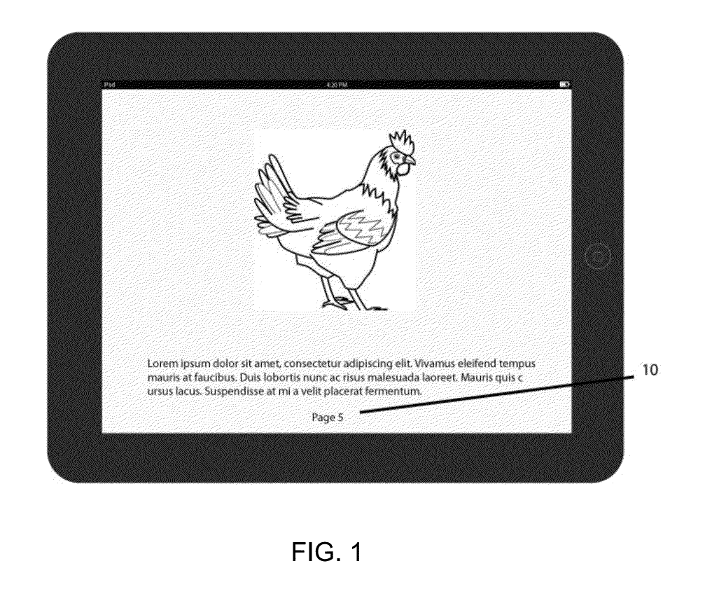

This invention is intended for use in, but not limited to, an illustrated digital book on a tablet computer device. It consists of the display and use of a new graphical user interface (GUI). A typical page of a graphical digital book combines artwork (FIG. 1) and text on a single screen, also called a page [10]. The illustrated digital book is commonly used for children's books, but it may be utilized in any book where graphical content is required, for example, in textbooks or illustrated process documents.

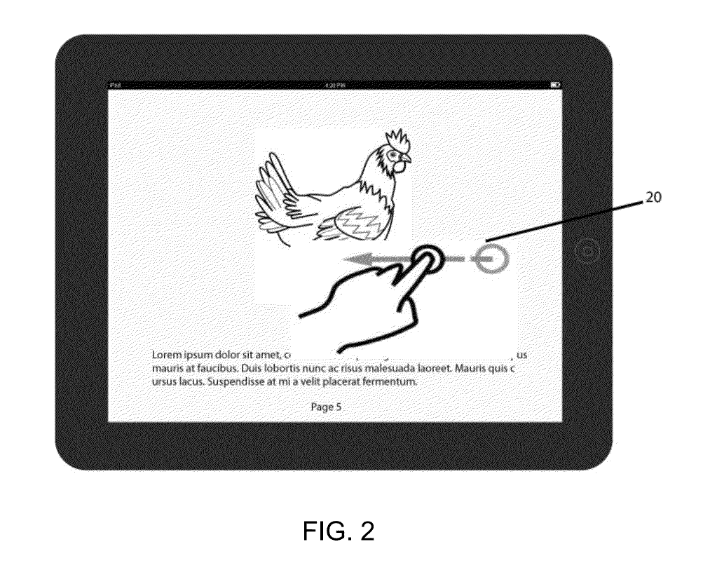

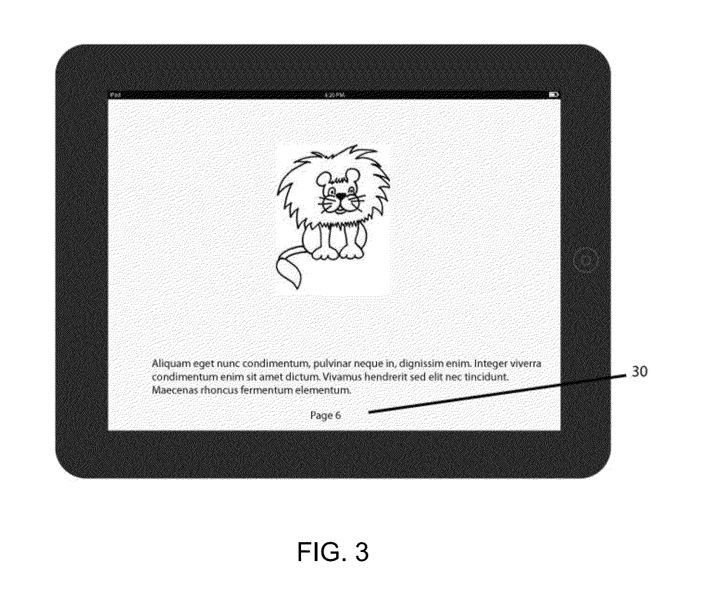

A typical navigation paradigm of a digital book on a tablet computer is the turning of a page in the digital book (FIG. 2). Switching or navigating to the next page in a digital book is done by the action of the reader or user. The user performs a sliding or swiping motion across the tablet computer screen with a single finger [20]. The single-finger swipe motion from right to left causes the display to change to the next page in the book, mimicking the turning of a page in a traditional physical paper book. Upon completion of the finger swipe action (FIG. 3), the next page of the digital book is displayed [30]. A single-finger swipe motion from left to right causes the display to change to the previous page.

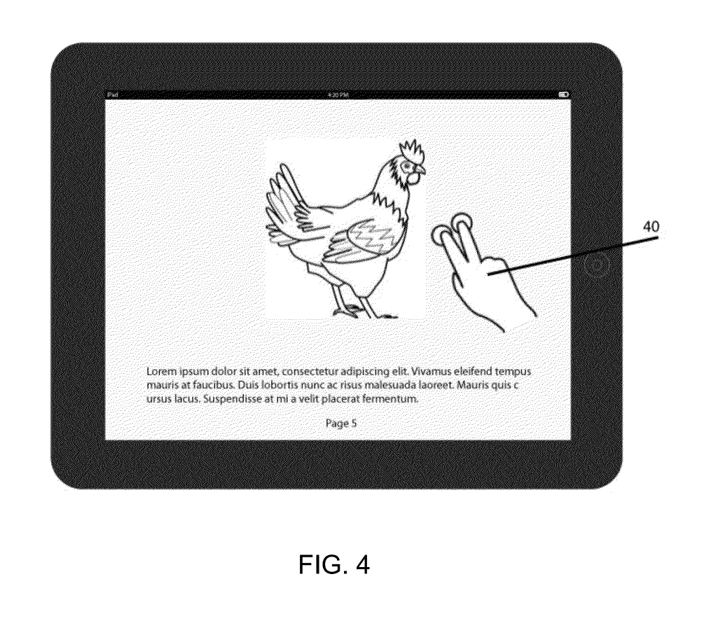

This invention is a new GUI navigation method and provides a more intuitive and rapid way to navigate to other pages in the digital book. The invention, the Digital Book Graphical Navigator, is an integral part of the digital book reading experience. From any page in the digital book (FIG. 4), the user initiates (displays) the Digital Book Graphical Navigator by performing a two-finger tap [40] action on the surface (screen) of the table computer. The Digital Book Graphical Navigator consists of two parts—the Digital Book Graphical Navigator Page Slider and the Digital Book Graphical Navigator Chapter Slider. The Digital Book Graphical Navigator Chapter Slider is used in conjunction with the Digital Book Graphical Navigator Page Slider when the digital book contains chapters. If there are only illustrated pages, as in a children's book, only the Digital Book Graphical Navigator Page Slider is used.

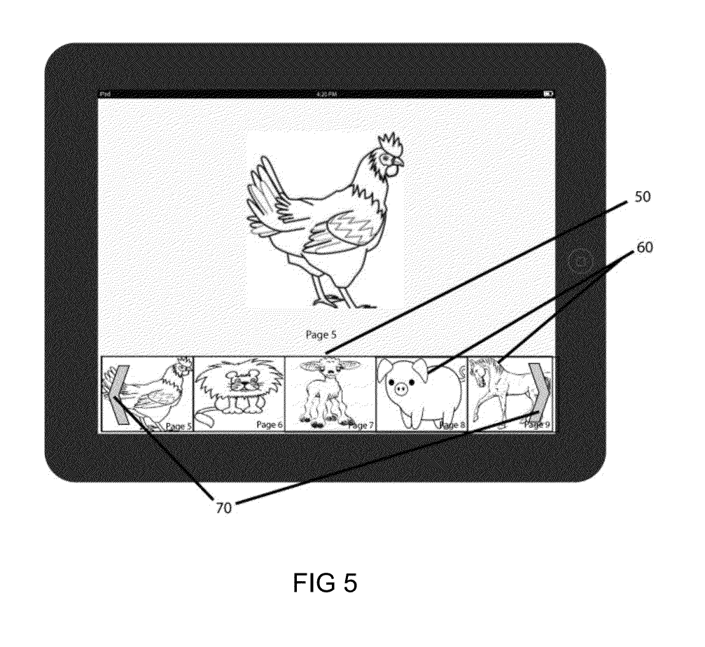

After the user performs a two-finger tap action, the Digital Book Graphical Navigator is displayed at the bottom of the tablet computer screen. In this example, only the Digital Book Graphical Navigator Page Slider is shown (FIG. 5). The Digital Book Graphical Navigator Page Slider is a horizontally oriented list of miniature (thumbnail) images [50], one for each page in the digital book. The Digital Book Graphical Navigator Page Slider displays five to six thumbnail images on a single tablet page (screen)[50]. The thumbnail images in the Digital Book Graphical Navigator Page Slider are miniature versions of each page in the digital book, sans the page text, and thus the image will change from book to book. Each thumbnail image represents a page in the digital book [60]. The thumbnail images are arranged in the same page order as the digital book, starting with page 1 through the last page in the digital book [50]. Arrows are displayed on the right and left sides [70] of the Digital Book Graphical Navigator Page Slider to indicate that there are more thumbnail images to view in the direction of the arrow. The arrow will be gray if there are no more pages to display in the direction of the arrow.

Other digital book navigation devices require the user to swipe through each page in the book in order to navigate to the desired page which is done page by page. This invention allows the user to more efficiently view several pages at a glance in a single view on the tablet page before selecting a desired page for full display.

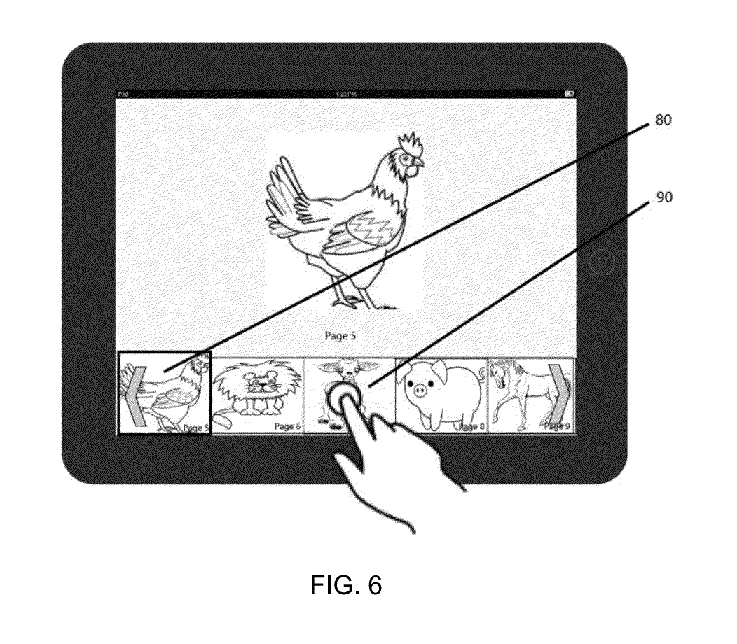

Five to six thumbnail images are displayed to the user at any one time. When the Digital Book Graphical Navigator Page Slider is displayed (FIG. 6), the thumbnail image of the current page is highlighted in the Digital Book Graphical Navigator Page Slider [80]. The Digital Book Graphical Navigator Page Slider thumbnail images remain in page order. Previous and subsequent thumbnail images are displayed when the user swipes to the left or to the right. Several previous and subsequent thumbnail images are displayed horizontally in the same view with the thumbnail representing the current page highlighted.

With this invention, the user is no longer limited to swiping one page at a time through the book. To select a new page to view, the user performs a single-finger tap action on the desired thumbnail image of the page in the Digital Book Graphical Navigator Page Slider [90].

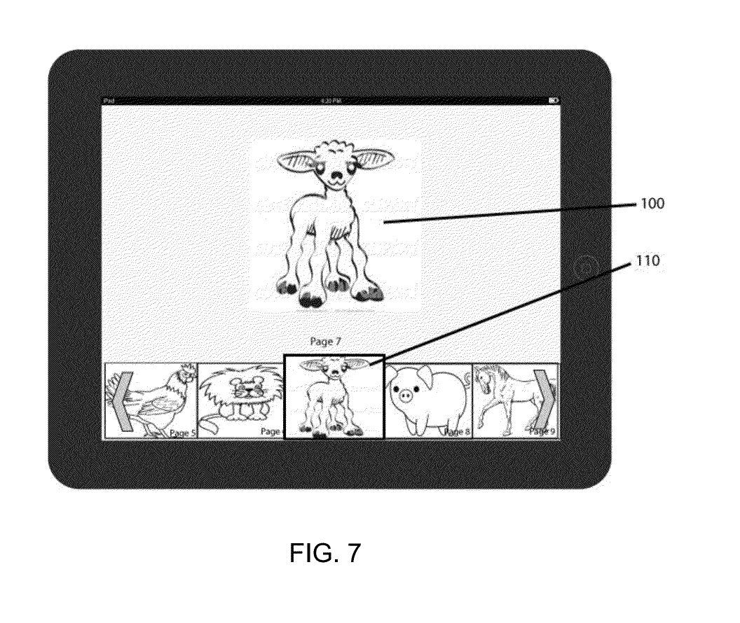

After the user performs a single-finger tap action on the desired thumbnail image of the Digital Book Graphical Navigator Page Slider (FIG. 7), the selected page is displayed as the primary page on the tablet computer [100]. The Digital Book Graphical Navigator remains displayed, and the thumbnail image of the current page is highlighted in the horizontally oriented list [110]. The previous and subsequent pages of the digital book are displayed as thumbnail images horizontally in the Digital Book Graphical Navigator Page Slider at the bottom of the tablet computer screen, overlaying the lower portion of primary display, but not interfering in any way with the features and functions of the primary display.

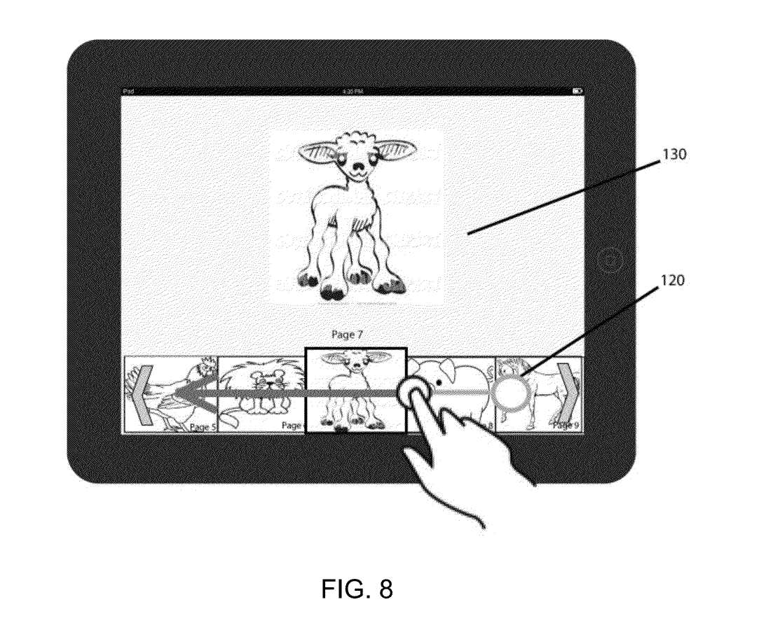

After the user performs a two-finger tap to display the Digital Book Graphical Navigator, he can rapidly view all the pages in the digital book by performing a single-finger swipe on the Digital Book Graphical Navigator Page Slider (FIG. 8). The primary page [130] display remains stationary while the user scrolls (navigates) through and views the pages in the form of thumbnail images in the Digital Book Graphical Navigator Page Slider. To view other thumbnail images in the Digital Book Graphical Navigator Page Slider, the user places a single finger on the tablet surface on a Digital Book Graphical Navigator Page Slider thumbnail image [120] and drags his finger from right to left to view the next thumbnail images, starting from the current page through the subsequent pages. Multiple single-finger swipe actions (one after the other) on the Digital Book Graphical Navigator Page Slider display the list of thumbnail images to the end of the list of pages in the digital book. A rapid swipe action causes the display to rapidly scroll by like a spinning wheel, slowing then stopping as the action loses momentum. A slower, single-finger drag and swipe action causes the display of the thumbnails to scroll by slowly for easy, clear viewing of each thumbnail image.

The primary page (FIG. 8) displayed on the tablet [130] remains stationary, while the Digital Book Graphical Navigator Page Slider thumbnail images scroll to the left. The speed of the finger swipe controls the speed at which the thumbnail images scroll. A quick finger swipe causes the thumbnail images to scroll rapidly. A slow single-finger drag across the tablet surface causes the thumbnail images to scroll very slowly.

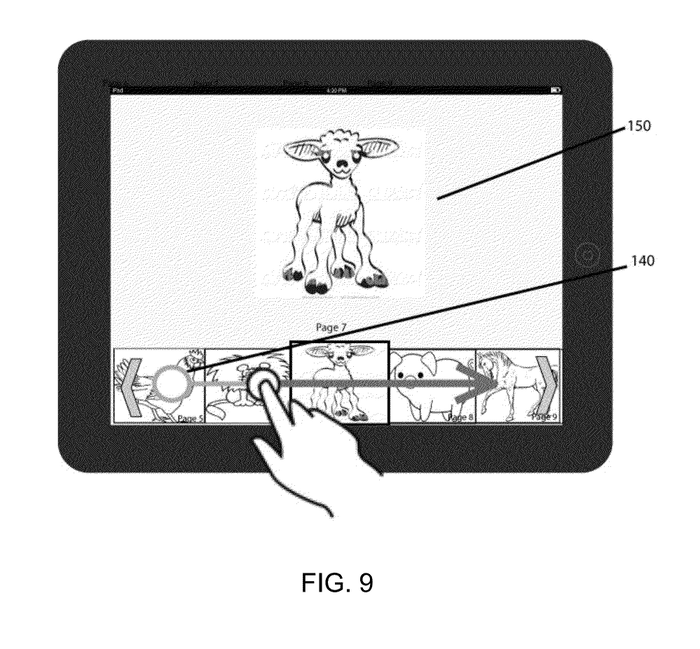

Dragging a single finger from left to right (FIG. 9) on the Digital Book Graphical Navigator Page Slider displays previous page thumbnail images [140]. The primary page displayed on the tablet [150] remains stationary, while the Digital Book Graphical Navigator Page Slider thumbnail images move to the right.

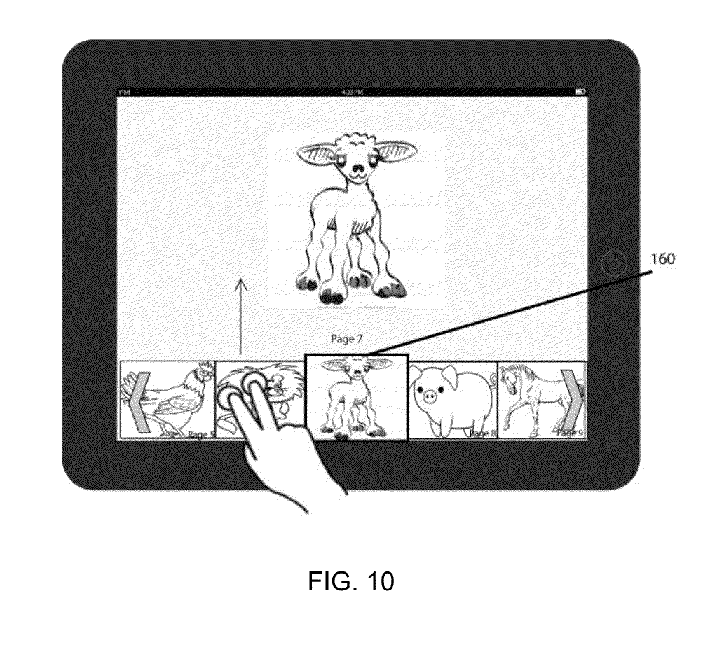

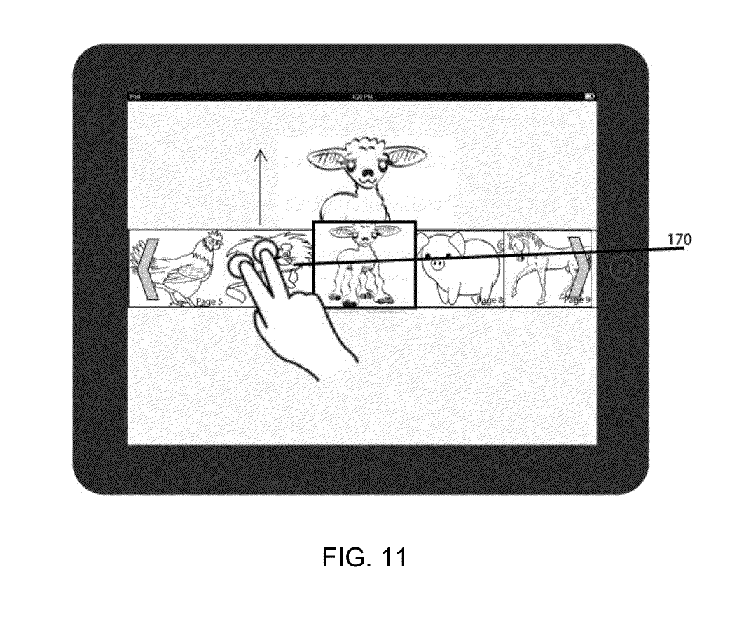

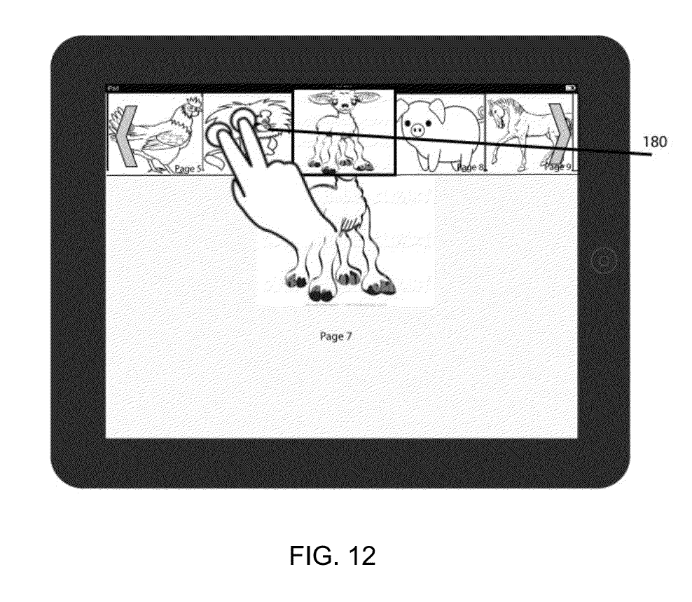

The user can drag the Digital Book Graphical Navigator from the bottom of the page to the top as needed to view what is concealed by the Digital Book Graphical Navigator (FIG. 10). To move the Digital Book Graphical Navigator, the user performs a two-finger tap-and-hold on the tablet page and on the Digital Book Graphical Navigator [160]. While still holding down on the Digital Book Graphical Navigator (FIG. 11), the user performs a drag motion on the surface of the tablet computer screen [170]. The user drags the Digital Book Graphical Navigator to the top of the tablet computer screen (FIG. 12) and releases his fingers [180]. This leaves the Digital Book Digital Book Graphical Navigator at the top of the tablet computer screen. While dragging the Digital Book Graphical Navigator from the bottom to the top of the tablet computer screen, once the Digital Book Graphical Navigator has passed the horizontal mid-point of the tablet computer screen (FIG. 11), the user can also release his finger from the tablet surface and the Digital Book Graphical Navigator will move automatically to the top of the tablet computer screen. The user may move the Digital Book Graphical Navigator back to the bottom of the tablet computer screen by performing the same dragging motion on the Digital Book Graphical Navigator from the top to the bottom of the tablet computer screen.

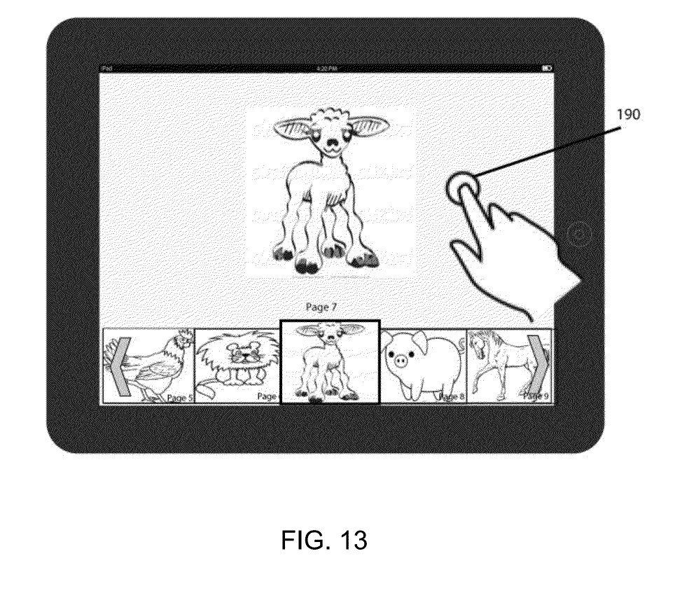

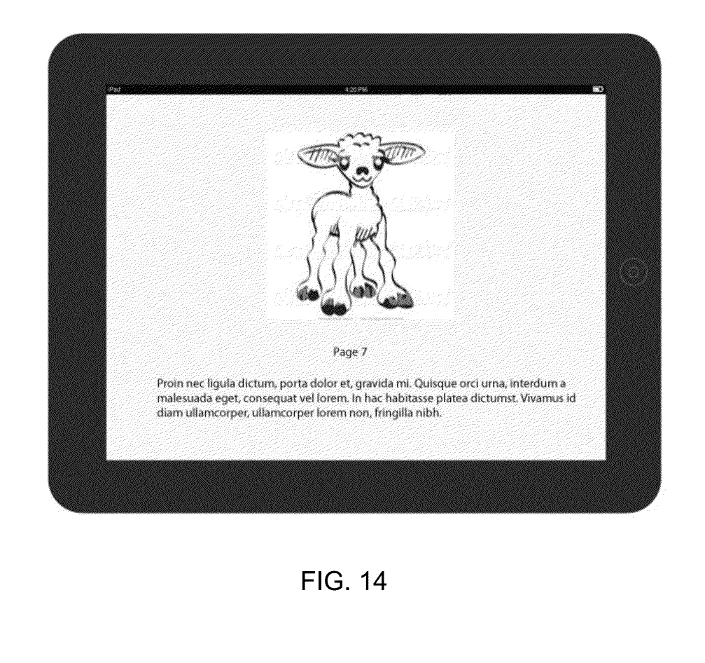

The Digital Book Graphical Navigator is removed from view (FIG. 13) when the user performs a single-finger tap anywhere on the surface of the tablet computer [190] away from the Digital Book Graphical Navigator. If there is no direct action taken by the user to remove the Digital Book Graphical Navigator from view, the Digital Book Graphical Navigator will fade away after a set amount of time (several seconds). This leaves the last selected page in full view on the tablet computer screen (FIG. 14).

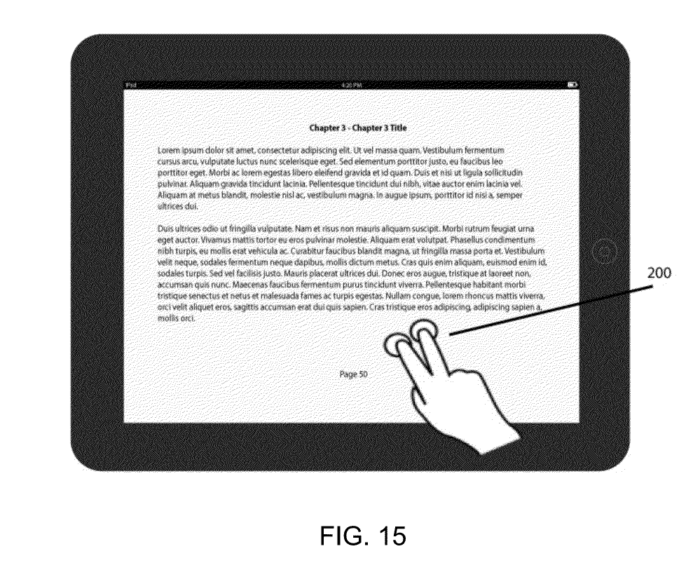

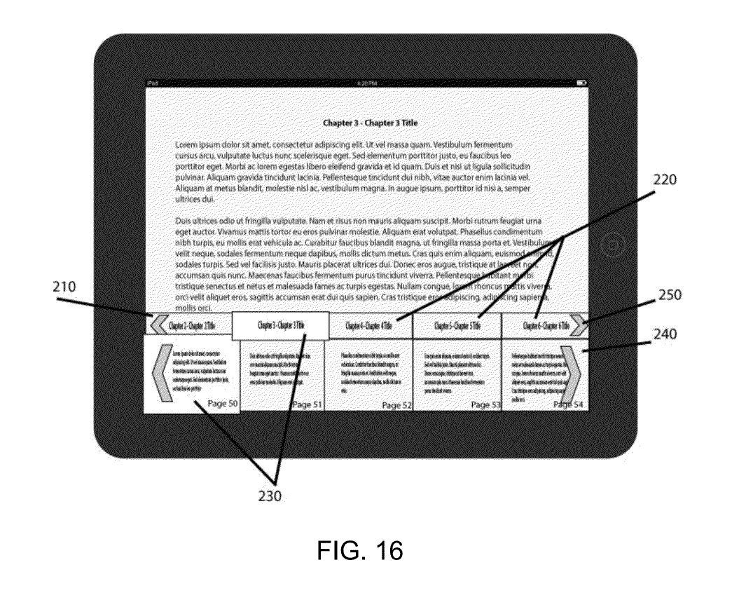

When the Digital Book Graphical Navigator is in use with a chapter book (FIG. 15), the user initiates the Digital Book Graphical Navigator in the same way as with a non-chapter book, with a two-finger tap action [200]. The Digital Book Graphical Navigator displays with a secondary horizontally oriented list for the chapters (FIG. 16), called the Digital Book Graphical Navigator Chapter Slider. This second, smaller navigation list that contains the book chapters is displayed in a horizontally oriented list of thumbnail images [210]. In the Digital Book Graphical Navigator Chapter Slider, each thumbnail image represents a chapter in the book [220]. The chapter thumbnail images are displayed in the order in which the chapters are available in the book. The current chapter and the current page are highlighted [230].

The Digital Book Graphical Navigator Chapter Slider [210] is smaller in size and is displayed above the Digital Book Graphical Navigator Page Slider [240]. The pages are still displayed in the Digital Book Graphical Navigator Page Slider [240]. Each thumbnail image for each page in the Digital Book Graphical Navigator Page Slider can be either a few sentences from the page or an image. The thumbnail images for each page are displayed in a horizontally oriented list as described in previous paragraphs for illustrated short stories (non-chapter books). Left and right arrows are displayed in the Digital Book Graphical Navigator Chapter Slider to indicate that there are more chapters before and after those displayed [250].

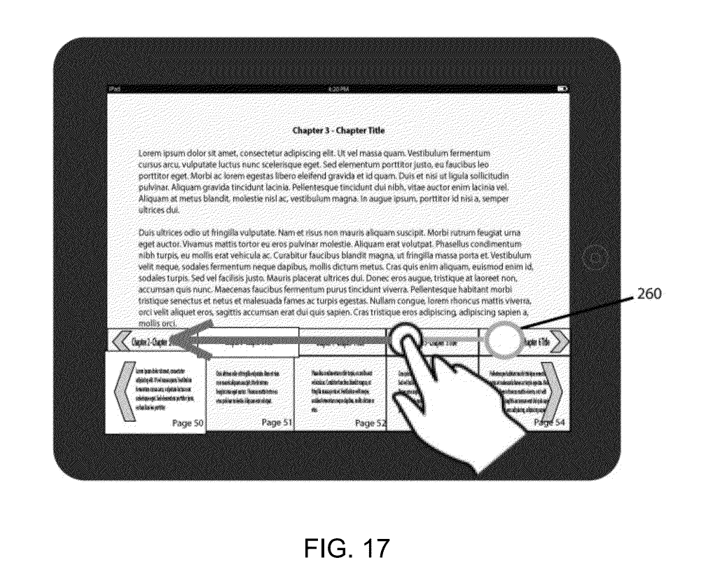

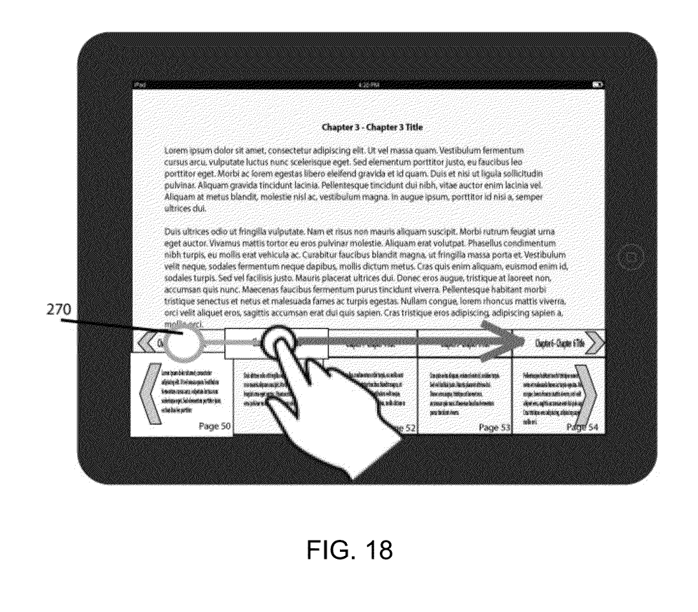

The action of scrolling through the Digital Book Graphical Navigator Chapter Slider (FIG. 17) is performed in the same manner described previously for the Digital Book Graphical Navigator Page Slider with a left or right single-finger swiping action. The user performs a single-finger tap-and-hold and drags his finger from right to left on the Digital Book Graphical Navigator Chapter Slider to scroll the list of chapters forward [260]. To scroll and view thumbnails for previous chapters (FIG. 18), the user performs a single-finger tap-and-hold on the chapter area of the Digital Book Graphical Navigator Chapter Slider and drags his finger from left to right [270]. The Digital Book Graphical Navigator Chapter Slider and the Digital Book Graphical Navigator Page Slider are swiped independently and can be scrolled left or right independently.

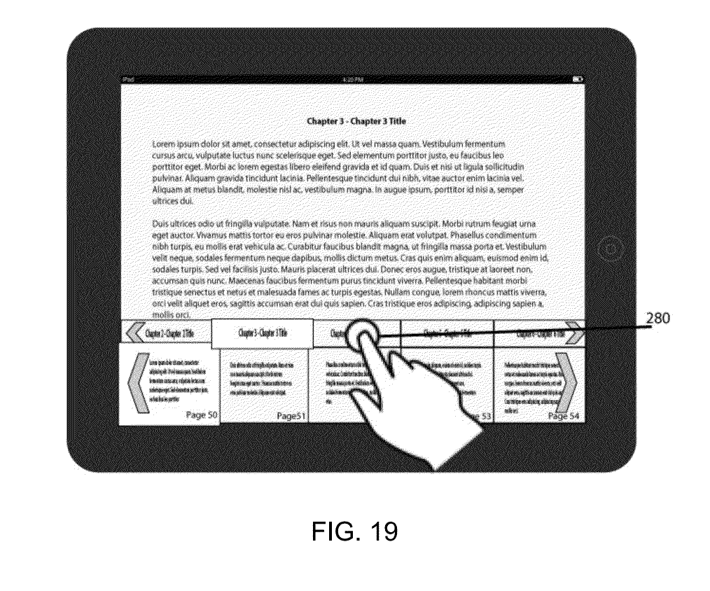

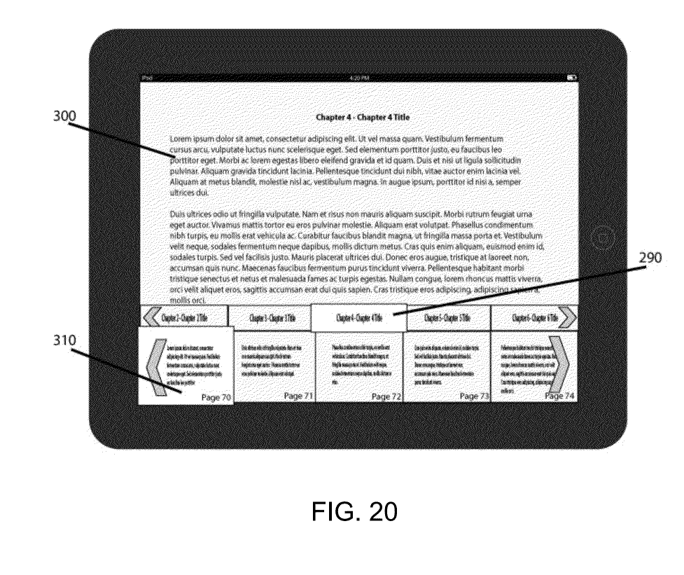

To navigate to a specific page (FIG. 19), the user first selects a chapter. To select a chapter, the user performs a single-finger tap action on the chapter in the Digital Book Graphical Navigator Chapter Slider [280]. In the example, chapter 4 is selected. After tapping a desired chapter (FIG. 20), the chapter in the Digital Book Graphical Navigator Chapter Slider is highlighted [290], and the first page in the chapter is displayed [300]. The pages for the selected chapter are displayed in the Digital Book Graphical Navigator Page Slider, and the first page of the chapter displayed in the Digital Book Graphical Navigator Page Slider is also highlighted [310]. In this example, chapter 4 is selected and is highlighted in the Digital Book Graphical Navigator Chapter Slider. Page 70 of chapter 4 is highlighted in the Digital Book Graphical Navigator Page Slider and is shown as the primary page on the tablet computer.

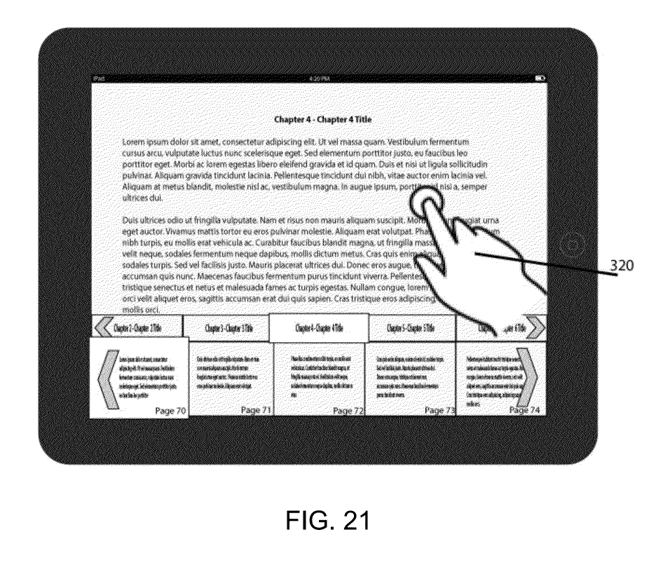

To dismiss the Digital Book Graphical Navigator in a chapter book, the user performs the same action as with a non-chapter book (FIG. 21). A single-finger tap [320] on the primary page dismisses the Digital Book Graphical Navigator and hides it from sight. The Digital Book Graphical Navigator will automatically be dismissed and fade away after several seconds of inactivity.

1. A user interface for tablet computer digital books consisting of
a) A graphical navigation sliding mechanism, called the Digital Book Graphical Navigator, consisting of horizontally oriented lists of miniature (thumbnail) page and chapter images where each thumbnail image represents a page or chapter in the digital book.
b) The Digital Book Graphical Navigator consists of two parts—the Digital Book Graphical Navigator Page Slider and the Digital Book Graphical Navigator Chapter Slider. For simple illustrated digital books, only the Digital Book Graphical Navigator Page Slider is used. For larger digital books containing chapters, the Digital Book Graphical Navigator Chapter Slider is used in conjunction with the Digital Book Graphical Navigator Page Slider.
c) A two-finger tap user action on the tablet computer screen to initiate and display the Digital Book Graphical Navigator.
d) A single-finger user action on the tablet computer screen tap to dismiss (hide) the Digital Book Graphical Navigator, or automatic dismissal of the Digital Book Graphical Navigator after a period of inactivity with the Digital Book Graphical Navigator.
e) User interaction with the Digital Book Graphical Navigator including swiping or scrolling left and right and selecting a thumbnail image to navigate to the page or chapter in the electronic book represented by the selected thumbnail images.
f) Display and management of the Digital Book Graphical Navigator on the tablet computer, when it is visible, such as dragging the Digital Book Graphical Navigator from the bottom to the top of the tablet computer screen.
